(19) United States
(12) Patent Application Publication
(10) Pub. No.: US 2005/0066166 A1
(43) Pub. Date: Mar. 24, 2005

(54) Unified wired and wireless switch architecture

(76) Inventors: Ken C.K. Chin, Saratoga, CA (US); Abhijit K. Choudhury, Cupertino, CA (US); Mathew Kayalackakom, Cupertino, CA (US); Shekhar Ambe, San Jose, CA (US)

Correspondence Address: Pillsbury Winthrop LLP;Intellectual Property Group, Suite 200, 11682 El Camino Real, San Diego, CA, 92130-2092, US

(21) Appl. No.: 10/884,364

(22) Filed: Jul. 2, 2004

Related U.S. Application Data
(60) Provisional application No. 60/484,991, filed on Jul. 3, 2003.

(51) Int. Cl. H04L 12/66

(52) U.S. Cl. 713/165

(57) ABSTRACT

An apparatus provides an integrated single chip solution to solve Switching/Bridging, Security, Access Control, Bandwidth Management—Quality of Service issues, Roaming—Clean Hand off, Anticipatory Load Management, Location Tracking, Support for Revenue Generating Services—Fine grain QoS, Bandwidth Control, Billing and management. The architecture is such that it not only resolves the problems pertinent to WLAN it is also scalable and useful for building a number of useful networking products that fulfill enterprise security in all possible combinations of wired and wireless networking needs.

### CROSS-REFERENCE TO RELATED APPLICATIONS

The present application claims priority to provisional application 60/484,991, filed on Jul. 3, 2003.

### FIELD OF THE INVENTION

Aspects of the present invention relate generally to network communications, and more particularly, to wired and wireless networks and architectures.

### BACKGROUND

The Wireless Local Area Network (WLAN) market has recently experienced rapid growth, primarily driven by consumer demand for home networking. The next phase of the growth will likely come from the commercial segment, such as enterprises, service provider networks in public places (Hotspots), multi-tenant, multi-dwelling units (MxUs) and small office home office (SOHOs). The worldwide market for the commercial segment is expected to grow from SM units in 2001 to over 33M units in 2006. However, this growth can be realized only if the issues of security, service quality and user experience are addressed effectively in newer products.

FIG. 1 illustrates possible wireless network topologies. As shown in FIG. 1, a wireless network 100 typically includes at least one access point 102, to which wireless-capable devices such as desktop computers, laptop computers, PDAs, and cellphones can connect via wireless protocols such as 802.11a/b/g. Several or more access points 102 can be further connected to an access point controller 104. Switch 106 can be connected to multiple access points 102, access point controllers 104, or other wired and wireless network elements such as switches, bridges, computers, and servers. Switch 106 can further provide an uplink to another network. Many possible alternative topologies are possible, and this figure is intended to illuminate, rather than limit, the present inventions.

Problems with security, in particular, are relevant to all possible deployments of wireless networks. Most of the security problems have been brought on by flaws in the WEP algorithm which seriously undermine the security of the system making it unacceptable as an Enterprise solution. In particular, current wireless networks are vulnerable to:
Passive attacks to decrypt traffic based on statistical analysis.
Active attack to inject new traffic from unauthorized mobile stations, based on known plaintext.
Active attacks to decrypt traffic, based on tricking the access point.
Dictionary-building attacks that, after analysis of about a day's worth of traffic, allows real-time automated decryption of all traffic.

Analysis suggests that all of these attacks can be mounted using only inexpensive off-the-shelf equipment. Anyone using an 802.11 wireless network should not therefore rely on WEP for security, and employ other security measures to protect their wireless network. In addition WLAN also has security problems that are not WEP related, such as:
Easy Access—“War drivers” have used high-gain antennas and software to log the appearance of Beacon frames and associate them with a geographic location using GPS. Short of moving into heavily shielded office space that does not allow RF signals to escape, there is no solution for this problem.
“Rogue” Access Points—Easy access to wireless LANs is coupled with easy deployment. When combined, these two characteristics can cause headaches for network administrators. Any user can run to a nearby computer store, purchase an access point, and connect it to the corporate network without authorization an thus be able to roll out their own wireless LANs without authorization.
Unauthorized Use of Service—For corporate users extending wired networks, access to wireless networks must be as tightly controlled as for the existing wired network. Strong authentication is a must before access is granted to the network.
Service and Performance Constraints—Wireless LANs have limited transmission capacity. Networks based on 802.11b have a bit rate of 11 Mbps, and networks based on the newer 802.11a technology have bit rates up to 54 Mbps. This capacity is shared between all the users associated with an access point. Due to MAC-layer overhead, the actual effective throughput tops out at roughly half of the nominal bit rate. It is not hard to imagine how local area applications might overwhelm such limited capacity, or how an attacker might launch a denial of service attack on the limited resources.
MAC Spoofing and Session Hijacking—802.11 networks do not authenticate frames. Every frame has a source address, but there is no guarantee that the station sending the frame actually put the frame “in the air.” Just as on traditional Ethernet networks, there is no protection against forgery of frame source addresses. Attackers can use spoofed frames to redirect traffic and corrupt ARP tables. At a much simpler level, attackers can observe the MAC addresses of stations in use on the network and adopt those addresses for malicious transmissions.
Traffic Analysis and Eavesdropping—802.11 provides no protection against attackers that passively observe traffic. The main risk is that 802.11 does not secure data in transit to prevent eavesdropping. Frame headers are always “in the clear” and are visible to anybody with a wireless network analyzer.

There are no enterprise-class wireless network management systems that can address all of these problems. Attempts have been made to address certain of these problems, usually on a software level.

Meanwhile, however, many WLAN vendors are integrating combined 802.11 algib standards into their chipsets. Such chipsets are targeted for what are called Combo —Access Points which will allow users associated with the Access Points to share 100 Mbits of bandwidth in Normal Mode and up to ˜300 Mbits in Turbo Mode. The table below shows why a software security solution without hardware acceleration is not feasible when bandwidth/speeds exceed 100 Mbits.

| | | Required Processor | | CPU |
|---|---|---|---|---|
| Interface | | Speed [MHz] | | Subsys |
| Type | BW [Mbs] | IPSec | IPSec + Other | Cost |
| DSL | 1-5 | 133 | 200+ | |
| Ether | 10 | 300 | 500+ | |
| 802.11a | 30-50 | 1200 | 1500+ | $400 |
| | | | | [2002] |
| | | | | $125 |
| | | | | [2004] |
| Fast | 100 | 2500 | 3000+ | $600 |
| Ether | | | | [2002] |
| | | | | $250 |
| | | | | [2004] |

| | | |
|---|---|---|
| Multiple | 500 | Not Feasible in Software |
| FE | | Needs Dedicated Hardware |
| Gigabit | 1000 | |
| Ether | | |

Network access raises several concerns. Organizations today need reliable, flexible and secure methods for making public and confidential information available to users who can be classified into employees, customers, suppliers, and partners. As a result Authentication for Access to enterprise network is best if based on Role, or relationship (Local/Remote employee, Executive, department, business partner, customer), Site Accessed (a protected web page, a partner site, company's intranet site, checking email, accessing confidential documents, or checking a partner price list) or Access restrictions based to the time of day or connection duration.

One final issue with respect to wireless networking is the problem of Roaming and Session Persistence. Roaming allows the user to move from one network to another (across same networks or across subnets). The user may do this intentionally to utilize a better or faster connection through a different Access Point or because user location has changed. Assuming that the user is originally authenticated while roaming user authentication across a WLAN should be transparent. The user should not require any manual action or any special application. There should be no reconfiguration needed when the user changes from one subnet to another. Any reconfiguration necessary should be done automatically. When roaming across subnets the WLAN user will encounter a problem with DHCP. As client changes network the new DHCP-server will provide a new IP-address. This will result in a break in an ongoing connection/session.

“Session persistence” means more than forwarding packets to a user's new location. “Persistence” can refer to just the problem of having packets forwarded as users roam among subnets, coverage areas and network types (wired LANs, wireless LANs and wireless WANs). More generally, it should refer to transport and application session persistence because when a transport protocol cannot communicate to its peer, the underlying protocols, like TCP, assume that the disruption of service is due to network congestion. When this occurs these protocols back off, reducing performance and eventually terminating the connection. WLAN networks have coverage holes causing dropouts even with access point overlap. This impacts a mobile device's range of mobility.

Although infrastructures for wired networks have been highly developed, the above and other problems of wireless networks are comparatively less addressed. Meanwhile, there is a need to address situations where enterprises and/or networks may have any combination of both wired and wireless components.

### SUMMARY

The embodiments of the present invention relate generally to a single-chip solution that addresses current weaknesses in wireless networks, but yet is scalable for a multitude of possible wired and/or wireless implementations. Current solutions to resolve/overcome the weaknesses of WLAN are only available in the form of Software or System implementations. These resolve only specific WLAN problems and they do not address all of the existing limitations of wireless networks. It also allows unified access control and management of both wired and wireless hosts in a network.

In accordance with an aspect of the invention, an apparatus may provide an integrated single chip solution to solve Switching/Bridging, Security, Access Control, Bandwidth Management—Quality of Service issues, Roaming—Clean Hand off, Anticipatory Load Management, Location Tracking, Support for Revenue Generating Services—Fine grain QoS, Bandwidth Control, Billing and management. The architecture is such that it not only resolves the problems pertinent to WLAN it is also scalable and useful for building a number of useful networking products that fulfill enterprise security and all possible combinations of wired and wireless networking needs.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates wireless network topologies;

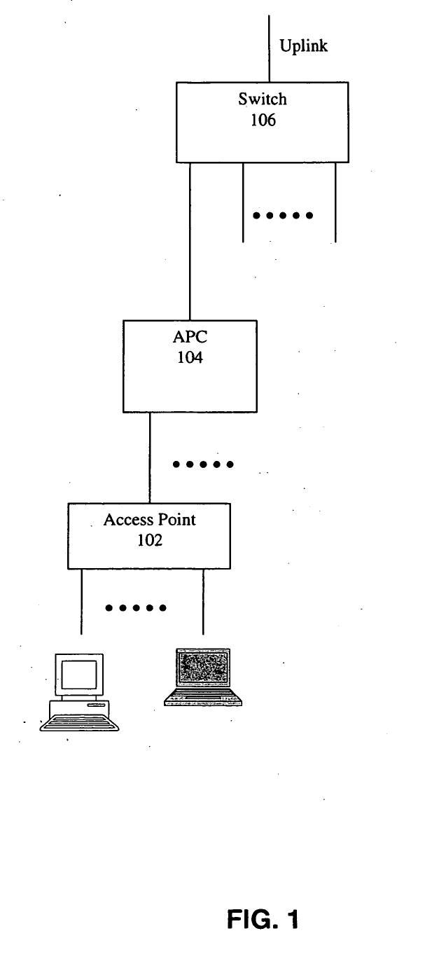

FIG. 2 is a block diagram illustrating a wired and wireless network device architecture in accordance with an embodiment of the present invention;

FIG. 3 is a block diagram illustrating an example implementation of a network device such as that illustrated in FIG. 2; and

FIGS. 4A to 4D illustrate various possible implementations of a network device illustrated in FIG. 2 in a wired and/or wireless network.

### DETAILED DESCRIPTION

One aspect of the invention is to deliver a single chip solution to solve wired and wireless LAN Security, Access Control, Roaming, Session Persistence, Bandwidth Management and Quality of Service issues. Such a single chip solution should also be scalable to enable implementation in the various components and alternative topologies of wired and/or wireless networks, such as, for example, in an access point, an access point controller, or in a switch. In some embodiments, network address translation (NAT) is performed, when enabled.

Embodiments of the present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the present invention can be partially or fully implemented using known components, only those portions of such known components that are necessary for an understanding of the embodiments will be described, and detailed descriptions of other portions of such known components will be omitted so as not to obscure the invention. Still further, aspects of the present invention encompass present and future known equivalents to the known components referred to herein by way of illustration, and implementations including such equivalents are to be considered alternative embodiments of the invention.

The attached Appendix forms part of the present disclosure and is incorporated herein by reference.

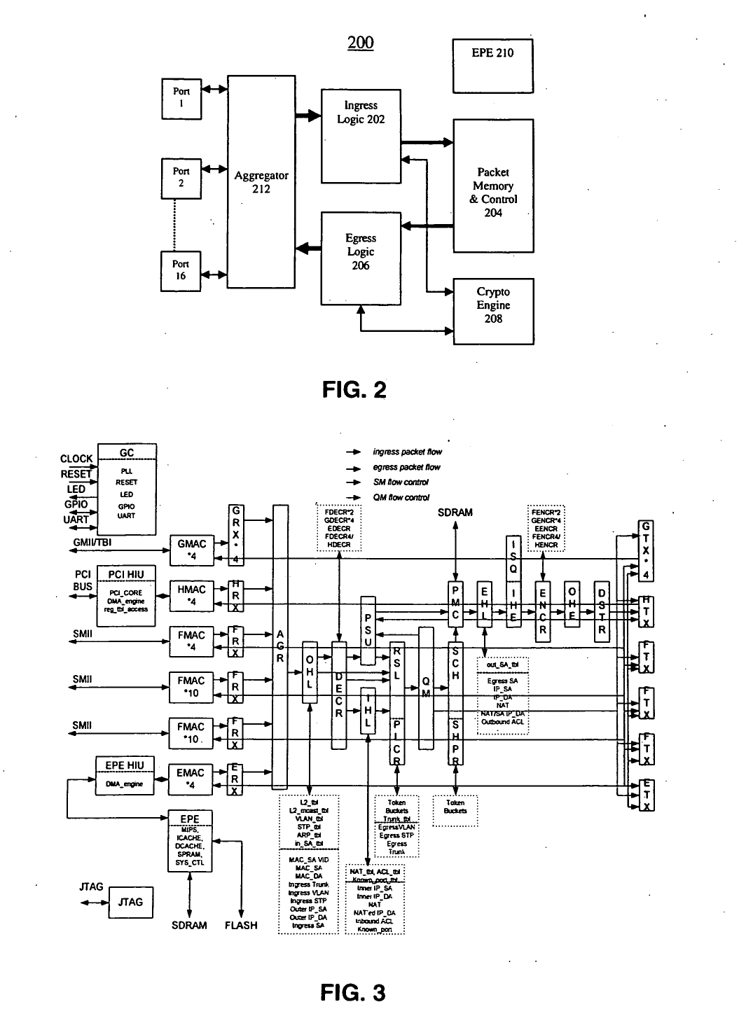

FIG. 2 is a block diagram illustrating an example implementation of a single-chip wired and/or wireless network solution in accordance with an aspect of the invention.

As shown in FIG. 2, chip 200 includes ingress logic 202, packet memory and control 204, egress logic 206, crypto engine 208, an embedded processor engine 210 and an aggregator 212.

The Ingress Logic 202 receives input from Input ports (e.g. Gig, FE, Embedded Processor Engine (EPE), CPU) via aggregator 212. The number and types of ports are design choices, and an aspect of the invention is that the number is scalable. Ingress Logic 202 receives both unencrypted and encrypted packets. Unencrypted packets are normal IP packets, while encrypted packets normally have two IP headers referred to as the Outer and Inner IP headers. The Outer IP Header is used for switching and routing. The Inner IP Header is not accessible in an encrypted packet until the packet is successfully decrypted. An Encrypted packet is sent to Decryptor block for packet authentication and decryption and information in the outer IP header is ignored. Once the Crypto authenticates and decrypts the packet further Ingress processing is done by Inner Header Lookup block. Ingress logic 202 performs following acts according to one example of the invention:
Determines if packet has to undergo decryption and authentication.
Performs various Table Lookups.
Checks for control messages like BPDU, GVRP, GMRP.
Checks for Spanning Tree Protocol states. The packet is forwarded or dropped based on the STP state of ingress port.
It assigns VLAN id for untagged packet.
If the packet is a tagged packet then the VLAN from the packet is used as VLAN.
If the packet is broadcast or Multicast then the port bitmaps are picked up based on the VLAN or multicast table entries.
It learns the source MAC Address, again based on STP states and port configuration, only if learning on the port is permitted.
If the packet is addressed to device 200 interface then VPN termination happens on the device. For encrypted packet the Ingress uses Crypto Engine to decrypt the packet.
The packet is then L3 switched based on destination IP Address.
The Ingress also does Rate limiting for Broadcast and Multicast embodiments.
It also implements Packet Filtering based on source MAC or Source IP addresses.
It keeps track of all the Ingress counters.
If the packet is not dropped by ACL then Ingress also performs Network address translation (NAT) functionality.
Some packets need Application Level Gateways (ALG). The ALGs are implemented in software running on Embedded Processor.
It sends the packet for ACL block for further processing.

Access Control List (ACL) is part of the user profile and available from LDAP server or Microsoft Active Directory Database. The Access control statements can be used to apply control based on. Group, Department, Organization, User, Application, Time of day, Source and Destination address, Flows and micro flows performed by packet scheduler in Packet Memory and Control block.

ACLs are also used for assigning the packet priority, policing and bandwidth management. Such ACL are called “QoS ACLs.” The QoS ACL is used for: Packet Classification, Packet Marking and Re-Marking (802.11p and/or DSCP—DiffServ Code Point). Policing using Token Bucket algorithm, Shaping uses the Token Bucket algorithm and is

Packet Memory may comprise of an Internal, external memory, Memory Controller, Queue Manager and a Scheduler. Internal or External Memory depending on the network device applications holds the packets that are waiting to egress out on Egress port of the device. Memory Controller manages the External Memory. A packet egresses based on queuing disciplines imposed on the traffic by the Queue Manager.

Collectively the Packet Memory and Control block 204 perform the following acts according to one example of the invention:
Write each packet in the packet memory (internal or external depending on network device application).
Enqueues the packet for the right queue/port if allowed BW is not exceeded.
Updates all the queue counters and also Ingress, Egress port counters.
The packet is now in the packet memory and the packet pointer is in the queue associated with Egress port
Scheduler at some point will schedule this packet based on the programmed scheduling algorithm and the associated parameters.
Once the scheduler selects the packet to send it out on the Egress port it reads the packet from the packet memory and sends it into Egress pipeline.

As set forth above, packet memory can be either in chip SRAM or it can be external DDR. The packet memory is shared by all ports and is mainly used for storing the packets. The SUMMiT-AP products have 256 Kbytes internal memory. There is no option for external DDR. But all other summit products can use external memory (DDR @ 200 MHz).

The Packet Memory Scheduler schedules the packet out of the Queue Manager queues and the corresponding data is retrieved from the Packet Memory Control. The outgoing packet will go through the Egress Header Lookup to determine required ACL actions and if encryption and authentication are required. It then undergoes packet header edit by the Inner Header Edit Block before being sent through the Encryptor Block for packet encryption and authentication. Additional packet editing if required, is performed in the Outer Header Edit Block and the aggregated traffic is then sent to the various Egress ports.

The acts that are performed by Egress Logic 206 according to one example of the invention are:
Egress Logic gets the packet from Packet Memory.
Perform Egress ACL Processing.
Perform NAT related packet editing.
If the Packet has to be encrypted then it requests the Crypto Engine to encrypt the packet.
The Egress Logic calculates CRC and compares with the CRC that is stored at the end of packet to check the packet validity. It discards the packet if the CRC does not match.
If the original packet is modified then the Egress recalculates the CRC.
It increments the Egress related counters.
Note: If the packet is a multicast packet then Egress may have to replicate the packet to send over the tunnels to multiple destinations. In such a situation the packets are encrypted based on the tunnel encryption for each station receiving the packet.

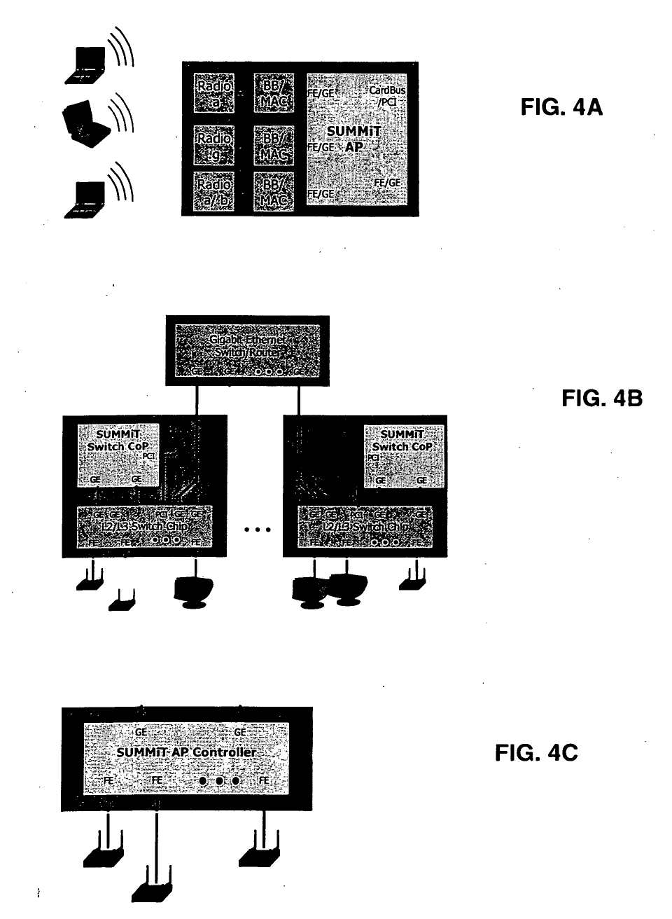

The Crypto Engine 208 comprises of cryptographic cores necessary to perform all authentication and encryption/decryption for IPSec, and L2TP. The crypto engine is split into two parts Decryptor Block and an Encryptor Block. In some embodiments, the decryptor block and encryptor block may be placed within other blocks, as depicted in FIG. 3.

All IPSec packets received and destined for the device 200 are forwarded to the Crypto Engine for authentication and decryption. Normally a VPN Session between WLAN Client and Access Point/Switch uses the IPSec tunnel mode (transport mode can be used for network management). The Pre-parsing is done by the Ingress logic to determine the type of packet, whether it is IKE, IPSec, L2TP or PPTP.

The ingress logic hands over all encrypted packets to Decryptor for authentication and decryption. Egress Block hands over all clear packets that require authentication and encryption to Encryptor. Acts of the Encryptor section of the crypto engine 208, according to one example of the invention, include:
Authenticate and De-crypt incoming packet from the WLAN side
Support IPSec Encryption algorithms (AES, DES, 3DES)
Support IPSec Authentication algorithms (HMAC MD5, SHA-1)
   Acts of the Decryptor section of the crypto engine 208, according to one example of the invention, include:
Authenticate and Encrypt packet going to the WLAN side
Support IPSec Encryption/Decryption algorithms (AES, DES, 3DES)
Support IPSec Authentication algorithms (HMAC MD5, SHA-1)

It serves to limit WLAN user access to domains, services and or applications on the wired side of the enterprise network. This works on top of privileges normally assigned to a user via network user id. Access Control Logic processes a list of rules top down that in total represent the overall corporate access policy for the user. The rules are grouped into what is commonly referred to as an Access Control List. Access Control Lists can be constructed to limit access from “no access” to “highly selective access.”

The Embedded Processing Engine (EPE) 210 comprises one or more on chip CPU cores (such as a MIPS core) used mainly for fast path processing of certain types of packets that are difficult to handle in hardware. This CPU can also be used for Control Path processing and implementing the acts of the Host CPU (as opposed to an external CPU) for the applications that are cost sensitive.

The Fast Path functionality implemented by the EPE according to one example of the invention can include:
Packet processing for PPTP protocol.
Packet processing for Van Jacobsen compression.
   Application Level Gateways (ALGs) for various applications such as NAT and Firewall
Layer 2 and 3 encapsulation—decapsulation
Proprietary Protocols
Fragmentation and Reassembly
Multicast and broadcast handling in case of packet replications on egress port
Intrusion detection using signature analysis and alarm signaling
Exception processing for other types of packet
Any other customer feature that needs to be in fast path and is not implemented in hardware.
   The Host CPU acts that can be done using the EPE, according to one example of the invention, include the following:
Processing of all Control packets.
Processing of Spanning Tree Protocol and other L2 protocols such as GMRP, GVRP, VLAN processing etc.
TCP/IP stack
Other applications such as telnet, TFTP, ping, DHCP, etc
IPSec Protocol stack
PPTP and L2TP Control messages
IKE processing
Authentication for new clients
SNMP stack for management
Web GUI for management
CLI functionality for management
DHCP relay
NAS client
SSL tunnel termination and processing
Application Level Gateways (ALGs) for various applications

The EPE(s) has access to all the on chip registers, memory and tables. It should also be able to DMA packets from device 200 Packet memory into memory in the PCI address space and vice versa. When EPE is the Host CPU, it will support packet transfers between device 200 and Host CPU and other WLAN NIC devices connected via PCI.

Aggregator 212 aggregates traffic from all the ports into a single stream of data for pipe-lined packet processing. In one example implementation, the output of this block is a 64-bit data stream plus a 10-bit of control information indicating receive port number, sop, eop, valid bytes, and CRC error status. To drop runt packets, aggregator 212 will have a (64+4)B buffer for each port so that before a packet can be sent downstream, it can be checked to see if it meets the minimum packet size requirement. This block also handles the receive MIB's.

FIG. 3 is a top-level block diagram of one example of a network device 200 in accordance with the present invention, with even further detailed description of various components thereof provided hereinbelow.

MAC (Media Access Controller)

This block contains FMAC, GMAC, EMAC, and HMAC. The FMAC is the fast Ethernet media access controller. The GMAC is the Gigabit Ethernet media access controller. The EMAC is the EPE (embedded processor engine) media access controller. There is no media concept for the EPE; however, this block works as a bridge between the EPE and the downstream packet processing so that the EPE will be treated like a data port similar to a fast Ethernet or a Gigabit Ethernet port except for the different data rate. The HMAC is the HIU (host interface unit) media access controller. Its function is similar to the EMAC.

RX (Receive)

This block contains FRX, GRX, ERX, and HRX. It sits between the MAC and the AGR. The FRX aggregates traffic from the 10 FMAC's before sending it to the AGR. The HRX aggregates traffic from the 4 HMAC's before sending it to the AGR. The ERX aggregates traffic from the 4 EMAC's before sending it to the AGR. Every RX block interfaces with the AGR with an 8-bit data bus and a 3 (+3 for FRX, +2 for HRX, +1 for ERX)-bit control bus with information such as sop, eop, and CRC error status (+receive port for FRX, HRX, and ERX).

AGR (Aggregator)

This block aggregates traffic from all the ports into a single stream of data for pipe-lined packet processing. The output of this block is a 64-bit data stream plus a 10-bit of control information indicating receive port number, sop, eop, valid bytes, and CRC error status. To drop runt packets, the AGR will have a (64+4)B buffer for each port so that before a packet can be sent downstream, it can be checked to see if it meets the minimum packet size requirement. This block also handles the receive MIB's.

OHL (Outer Header lookup)

This block performs the following lookups: MAC_SA VLAN ID, MAC_SA, MAC_DA unicast, MAC_DA multicast, outer IP_DA, outer IP_SA, and SA. The SA lookup is used to determine what kind of decryption needs to be done on the packet. The lookup key for the lookups is extracted from the packet. The OHL is passed with 64-bit of a packet at a time, so the parsing is done in an incremental manner. The data from the AGR is buffered in this block until the lookup is finished. The lookup results together with the buffered data are then sent to the DECR. Some lookup results are sent to the RSL directly.

DECR (Decryptor)

The Decryptor supports 4 authentication algorithms: MD5, SHA-1, HMAC-MD5 and HMAC-SHA-1, and 3 decryption algorithms: DES, 3DES, and AES. The DECR contains separate cores for FE, GE, PCI, and EPE traffic. The decrypted plaintext is stored into the PMC by the PSU. In the mean time, the data is sent to the IHL for inner header lookups. The authentication result is saved into a FIFO which will be read by the RSL together with the IHL lookup results and the PSU packet storage result. The decryption and authentication are done in parallel.

IHL (Inner Header Lookup)

This block performs the following lookups: inner IP_DA, inner IP_SA, NAT, NAT'ed IP_DA, and ACL. All the lookups are performed in parallel whenever possible and the results are saved into FIFO's so that the RSL can examine them together with the OHL lookup result, the authentication result and the plaintext storage result.

PSU (Payload Storage Unit)

This block maintains 36 packet storing contexts which includes the prefetched free buffers, the current buffer, the current location in the buffer (or the cell count), the partial cell data, and whether the packet has no buffer or no queue for further storing. After a packet is completely stored into the PMC, the packet length and the CRC error status is stored into a FIFO.

RSL (Resolution)

This block takes the lookup results from the OHL, the DECR, and the IHL, and the PSU storage result to determine how to forward the packet. The RSL will do policing and VLAN lookup (then STP lookup) in parallel, and trunking lookup will be performed after the final portmap is determined. Egress port mirroring is determined after trunking. The result is sent to the QM to queue the packet.

PLCR (Policer)

This block only interfaces with the RSL block and its major function is to police the packets classified into up to 4K flows. This block contains 4K token buckets.

QM (Queue Manager)

The QM may comprise dynamic queues implemented with linked lists. The following data structures are used to maintain the linked list queues: packet linked list memory (pkt_ll_mem), head memory (head_mem), tail memory (tail_Mem), and queue empty status (queue_empty_mem). Free queue head, tail, and count are also contained in the data structures.

SCH (Scheduler)

The QM sends enqueuing information to the SCH so that it knows when a queue is available for scheduling. The queue count memory (queue_ctr_tbl) is used to keep track of the queue size. There are 2 distinct schedulers, one for SP (strict priority), and one for class based weighted fair queuing (CBWFQ).

SHPR (Shaper)

This block only interfaces with the SCH block and its major function is to regulate the traffic out of the 4K queues. This block contains 4K token buckets.

PMC (Packet Memory Control)

To manage the shared memory, a MMU is used. The SDRAM shared memory is 32 MB and is partitioned into 32K buffers with each buffer 1 KB. The MMU has a 32K×15 buffer linked list (mmu_linked_list) to mange the buffer linking for a packet. A set of variables, free_buf_tail, free_buf_head, and free_buf_cnt, are used to maintain the free buffer list. To support multicast, a buffer release counter memory (rel_ctr_mem) is used to keep track of the buffer usages.

EHL (Egress Header Lookup)

This block performs two major lookups: outbound ACL and outbound SA. The outbound ACL is used to determine whether the packet needs to be dropped. The outbound SA is used to determine what kind of encryption needs to be performed on the packet. The EHL is passed with 64-bit of the packet at a time, so the key extraction is done in an incremental way. After the ACL and the SA lookups are finished, the buffered data together with the lookup result is sent to the ENCR.

IHE (Inner Header Editor)

This block processes the aggregate traffic in a pipeline with various processing stages. Before the ACL and the SA lookups are finished, the data can not be sent to the ENCR and will be saved into a temporary buffer (ihe_fifo). This block is implemented with an n-stage pipeline with each stage performing one editing task such as VLAN ID insert/strip, MAC DA and MAC SA replacement/TTL and checksum adjustment for routed packets, and so on. The packet dropped by the ACL will not be sent to the ENCR.

ISQ (IHE Shared Memory and Queue)

This block contains a shared memory and queue for the egress packets and only interfaces with the IHE block.

ENCR (Encryptor)

The Encryptor supports 4 authentication algorithms: MD5, SHA-1, HMAC-MD5, and HMAC-SHA-1. It also supports 3 encryption algorithms: DES, 3DES, and AES. The plaintext packet is encrypted first and then authenticated. The ENCR contains separate cores for FE, GE, PCI, and EPE. After the encryption is done, the block data is sent to the OHE (outer header editor). The data from the OHE will be sent to the DSTR (distributor) which will then distribute the data to the appropriate TX.

OHE (Outer Header Editor)

This block processes the aggregate traffic in a pipeline with various processing stages. This block is implemented with an n-stage pipeline with each stage performing one editing task such as ESP header insert for IPsec packets, and so on.

DSTR (Distributor)

The DSTR takes the edited aggregate traffic and distributes it to the appropriate TX port. This is a simple block and can be integrated with the OHE block. This block also handles the transmit MIB's.

TX (Transmit)

This block sits between the MAC and the DSTR. It contains FTX, GTX, ETX, and HTX. The FTX distributes the aggregated traffic from the DSTR to 10 FMAC's. The HTX distributes the aggregated traffic from the DSTR to 4 HMAC's. The ETX distributes the aggregated traffic from the DSTR to 4 EMAC's.

HIU (Host Interface Unit)

The HIU contains a PCI core (pci_core), a DMA engine (dma_engine), a host command interpretor (host_cmd_interpretor) and a register and table access logic (reg_tbl_logic). Only one register, gib_addr_reg, is used to trigger the DMA operation. A mode bit can be set by using the PCI configuration cycles to let the PCI access Summit registers and tables directly without having to go through the DMA engine.

EPE (Embedded Processor Engine)

The EPE has a MIPS core, a system controller (mips_sys_ctl), a data cache (data_cache), an instruction cache (instr_cache), a FLASH controller connected to the ISPRAM interface, and a SPRAM connected to the DSPRAM interface. The EPE can be used as a control CPU, in which case it interfaces with the HIU to transfer packet or table data between the MIPS core and the data ports.

GC (Global Controller)

This block generates clock and reset signals for the entire chip. The LED and GPIO control are also done by this block if needed. This block also contains 2 M16550S type of UART IP cores.

JTAG

This block controls boundary scan and full scan test. It contains a Tap Controller.

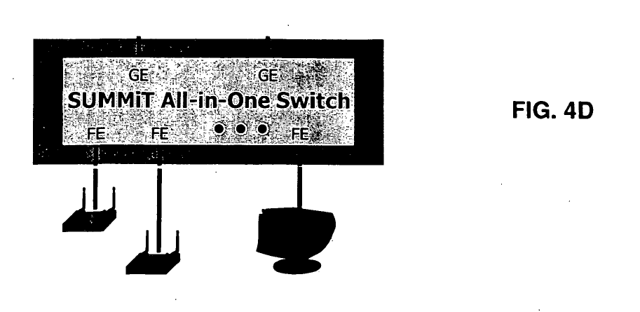

FIGS. 4A to 4D illustrate various implementations of the present invention that are made possible by the scalability features of the disclosed chip architecture.

The implementation in FIG. 4A illustrates a possible Enterprise Access Point application. In this application, device 200 has 3 MII interfaces to connect to WLAN interfaces and 1 GMII interface to connect to wired network. By having three interfaces, summit can support a dual-combo of 802.11a (5 GHz) and 802.11b or g (2.4 GHz) and a proprietary WLAN interface that can used specifically for meshing.

The implementation in FIG. 4B illustrates a possible Wireless Ready Enterprise class switch where device 200 can be used as a co-processor along with standard Ethernet 24 FE+2 Gig or 24 FE+4 Gig switch from other vendors. Co-processor 200 has two gigabit interfaces. One of the interfaces can be used to connect to gigabit port of the switch and the other can be used as an uplink or both the interfaces can be used to connect to a switch as shown in the figure.

The implementation in FIGS. 4C and 4D illustrate the ability of the present invention to integrate co-processor and switch functionality on a single chip. Device 200 in FIGS. 4C and 4D can be used for Wireless ready Small and Medium Enterprise applications or Access Point Concentrator. There are 8 SMII interfaces for 8 FE ports and 2 GMII interfaces for Gig ports on this device. Various applications using this device are illustrated in FIGS. 4C and 4D.

Although the present invention has been particularly described with reference to the embodiments herein, it should be readily apparent to those of ordinary skill in the art that changes and modifications in the form and details may be made without departing from the spirit and scope of the invention. It is intended that the appended claims include such changes and modifications.

1. An apparatus for application in a wired and/or wireless network comprising:
a scalable ingress path;
a scalable egress path;
an aggregator configured to receive packets from ports, configured to provide a stream for the ingress path, configured to receive a stream from the egress path, and configured to output packet data to the ports.

2. The apparatus of claim 1 further comprising:
a decryptor block configured to perform decryption of the stream from the ingress path.

3. The apparatus of claim 2 further comprising:
an encryptor block configured to perform encryption of the stream from the egress path.

4. The apparatus of claim 3, wherein the scalable ingress path is further configured to determine whether the stream for the ingress path has to undergo decryption.

5. The apparatus of claim 3, wherein the scalable ingress path is further configured to determine whether the stream for the ingress path has to undergo authentication.

6. The apparatus of claim 4, further comprises:
a packet memory configured to store data from the stream for the ingress path and to the data stream for the egress path.

7. The apparatus of claim 6, further comprises:
a packet memory scheduler configured to schedule the data from the packet memory to the data stream for the egress path.

8. The apparatus of claim 7, wherein the scalable egress path is further configured to determine whether the stream for the egress path has to undergo encryption.

9. The apparatus of claim 8, wherein the scalable egress path is further configured to request that the encryptor block encrypt the stream for the egress path.

10. The apparatus of claim 9, wherein the decryptor block or the encryptor block supports IPSec, L2TP with IPSec, PPTP, or SSL Encryption algorithms.

11. The apparatus of claim 10, wherein the decryptor block or the encryptor block supports IPSec, L2TP with IPSec, PPTP, or SSL authentication algorithms.

12. The apparatus of claim 9, wherein the egress path or the ingress path further comprises:
access control logic configured to forward packets based an entry in an access control list.

13. The apparatus of claim 12, wherein the access control logic is further configured to:
drop packets based the entry on the access control list.

14. The apparatus of claim 13, wherein the access control logic is further configured to:
redirect packets based the entry on the access control list.

15. The apparatus of claim 14, wherein the packet is redirected to a port.

16. The apparatus of claim 13, wherein the access control logic is further configured to:
modify packets based the entry on the access control list.

17. The apparatus of claim 16, wherein the access control logic modifies 802.11p or DiffServ Code Point (DSCP) fields of the packet.

18. The apparatus of claim 13, wherein the access control logic is further configured to:
send the packet to a central processing unit (CPU) or Embedded Processing Engine (EPE) based the entry on the access control list.

19. The apparatus of claim 13, wherein the access control logic is further configured to:
update a counter based the entry on the access control list.

20. The apparatus of claim 13, wherein the access control logic is further configured to:
assign a queue identifer to the packet based the entry on the access control list.

21. An method of processing data packets in a wired and/or wireless network comprising:
receiving a packet stream from one or more ports;
providing the packet stream to a scalable ingress path;
storing the packet stream;
outputting the packet stream to the one or more ports via a scalable egress path.

22. The method of claim 21 further comprising:
determining whether the packet stream received from one or more ports has to undergo decryption.

23. The method of claim 22 further comprising:
decrypting the packet stream received from one or more ports when the packet stream requires decryption.

24. The method of claim 23 further comprising:
determining whether the packet stream received from one or more ports has to undergo authentication.

25. The method of claim 24 further comprising:
authenticating the packet stream received from one or more ports when the packet stream requires authentication.

26. The method of claim 25, further comprises:
scheduling the output of the packet stream to the one or more ports via a scalable egress path.

27. The method of claim 26, further comprises:
determining whether the packet stream in the scalable egress path has to undergo encryption.

28. The method of claim 27 further comprising:
encrypting the packet stream when the packet stream in the scalable egress path has to undergo encryption.

29. The method of claim 28, further comprising:
encrypting the packet stream for the egress path.

30. The method of claim 29, wherein the encryption is an IPSec, L2TP with IPSec, PPTP, or SSL Encryption algorithm.

31. The method of claim 30, wherein the authentication is an IPSec, L2TP with IPSec, PPTP, or SSL Authentication algorithm.

32. The method of claim 29, further comprising:
forwarding packets based an entry in an access control list.

33. The method of claim 32, further comprising:
dropping packets based the entry on the access control list.

34. The method of claim 33, further comprising:
redirecting packets based the entry on the access control list.

35. The method of claim 34, wherein the packet is redirected to a port.

36. The method of claim 33, further comprising:
modifying packets based the entry on the access control list.

37. The method of claim 36, wherein 802.11p or DiffServ Code Point (DSCP) fields of the packet are modified.

38. The method of claim 33, further comprising:
sending the packet to a central processing unit (CPU) or Embedded Processor Engine (EPE) based the entry on the access control list.

39. The method of claim 33, further comprising:
updating a counter based the entry on the access control list.

40. The method of claim 33, further comprising:
assigning a queue identifier to the packet based the entry on the access control list.

41. A computer-readable medium, encoded with data and instructions, such that when executed by a computer, the instructions causes the computer to:
receive a packet stream from one or more ports;
provide the packet stream to a scalable ingress path;
store the packet stream;
output the packet stream to the one or more ports via a scalable egress path.

42. The computer-readable medium of claim 41 further comprising instructions to:
determine whether the packet stream received from one or more ports has to undergo decryption.

43. The computer-readable medium of claim 42 further comprising instructions to:
decrypt the packet stream received from one or more ports when the packet stream requires decryption.

44. The computer-readable medium of claim 43 further comprising instructions to:
determine whether the packet stream received from one or more ports has to undergo authentication.

45. The computer-readable medium of claim 44 further comprising instructions to:
authenticate the packet stream received from one or more ports when the packet stream requires authentication.

46. The computer-readable medium of claim 45, further comprises instructions to:
schedule the output of the packet stream to the one or more ports via a scalable egress path.

47. The computer-readable medium of claim 46, further comprises instructions to:
determine whether the packet stream in the scalable egress path has to undergo encryption.

48. The computer-readable medium of claim 47 further comprising instructions to:
encrypt the packet stream when the packet stream in the scalable egress path has to undergo encryption.

49. The computer-readable medium of claim 48, wherein the encryption is an IPSec, L2TP with IPSec, PPTP, or SSL Encryption algorithm.

50. The computer-readable medium of claim 49, wherein the authentication is an IPSec, L2TP with IPSec, PPTP, or SSL Authentication algorithm.

51. The computer-readable medium of claim 48, further comprises instructions to:
forward packets based an entry in an access control list.

52. The computer-readable medium of claim 51, further comprises instructions to:
drop packets based the entry on the access control list.

53. The computer-readable medium of claim 52, further comprises instructions to:
redirect packets based the entry on the access control list.

54. The computer-readable medium of claim 53, wherein the packet is redirected to a port.

55. The computer-readable medium of claim 52, further comprises instructions to:
modify packets based the entry on the access control list.

56. The computer-readable medium of claim 55, wherein the access control logic modifies 802.11p or DiffServ Code Point (DSCP) fields of the packet.

57. The computer-readable medium of claim 52, further comprises instructions to:
send the packet to a central processing unit (CPU) or Embedded Processor Engine (EPE) based the entry on the access control list.

58. The computer-readable medium of claim 52, further comprises instructions to:
update a counter based the entry on the access control list.

59. The computer-readable medium of claim 52, further comprises instructions to:
assign a queue identifer to the packet based the entry on the access control list.

60. An apparatus of processing data packets in a wired and/or wireless network comprising:
means for receiving a packet stream from one or more ports;
means for providing the packet stream to a scalable ingress path;
means for storing the packet stream;
means for outputting the packet stream to the one or more ports via a scalable egress path.

61. The apparatus of claim 60 further comprising:
means for determining whether the packet stream received from one or more ports has to undergo decryption.

62. The apparatus of claim 61 further comprising:
means for decrypting the packet stream received from one or more ports when the packet stream requires decryption.

63. The apparatus of claim 62 further comprising:
means for determining whether the packet stream received from one or more ports has to undergo authentication.

64. The apparatus of claim 63 further comprising:
means for authenticating the packet stream received from one or more ports when the packet stream requires authentication.

65. The apparatus of claim 64, further comprises:
means for scheduling the output of the packet stream to the one or more ports via a scalable egress path.

66. The apparatus of claim 65, further comprises:
means for determining whether the packet stream in the scalable egress path has to undergo encryption.

67. The apparatus of claim 66 further comprising:
means for encrypting the packet stream when the packet stream in the scalable egress path has to undergo encryption.

68. The apparatus of claim 67, wherein the encryption is an IPSec, L2TP with IPSec, PPTP, or SSL Encryption algorithm.

69. The apparatus of claim 68, wherein the authentication is an IPSec, L2TP with IPSec, PPTP, or SSL Authentication algorithm.

70. The apparatus of claim 67, wherein the egress path further comprises:
means for forwarding packets based an entry in an access control list.

71. The apparatus of claim 70, further comprising:
means for dropping packets based the entry on the access control list.

72. The apparatus of claim 71, further comprising:
means for redirecting packets based the entry on the access control list.

73. The apparatus of claim 72, wherein the packet is redirected to a port.

74. The apparatus of claim 71, further comprising:
means for modifying packets based the entry on the access control list.

75. The apparatus of claim 74, wherein the access control logic modifies 802.11p or DiffServ Code Point (DSCP) fields of the packet.

76. The apparatus of claim 71, further comprising:
means for sending the packet to a central processing unit (CPU) or Embedded Processor Engine (EPE) based the entry on the access control list.

77. The apparatus of claim 71, further comprising:
means for updating a counter based the entry on the access control list.

78. The apparatus of claim 71, further comprising:
assign a queue identifier to the packet based the entry on the access control list.
